(19) United States
(12) Patent Application Publication
(10) Pub. No.: US 2026/0190097 A1
(43) Pub. Date: Jul. 2, 2026

(54) METHOD OF ALLOCATING UPLINK RESOURCES IN WIRELESS COMMUNICATIONS NETWORK

(71) Applicant: Hong Kong Applied Science and Technology Research Institute Co., Ltd, Shatin (HK)

(72) Inventors: Xun CHEN, Mong Kok (HK); Liqiong LIU, Tai Po (HK); Zizhou WANG, Shatin (HK); Eddy CHIU, Kowloon (HK)

(21) Appl. No.: 19/005,117

(22) Filed: Dec. 30, 2024

(51) Int. Cl. H04W 72/0453; H04B 17/309; H04W 72/02; H04W 72/542

(52) U.S. Cl. CPC H04W 72/0453; H04B 17/346; H04W 72/02; H04W 72/542

(57) ABSTRACT

A method of allocating uplink resources in wireless communications network. The wireless communication network includes a plurality of UEs and a base station (BS). The method includes the steps of: for each of the UEs, setting up a signal quality record for RBs; estimating a requirement of RBs for each of the UEs, based on a measured signal quality at the UE; selecting an optimal sub-band in a spectrum for each of the UEs based on their respective requirements of RBs; and updating the signal quality record for each of the UEs based on an updated signal quality at the UE in the optimal sub-band. Therefore, the uplink resource allocation method is provided with feedback loops, which enhance the overall throughput performance.

### FIELD OF INVENTION

This invention relates to the field of network resource management of mobile communication networks, for example Long Term Evolution (LTE) networks and 5G networks.

### BACKGROUND OF INVENTION

Frequency Selective Scheduling (FSS) is a technique used in wireless communication systems, particularly LTE networks, to optimize the allocation of radio resources based on the varying quality of different frequency sub-bands. This method leverages the inherent characteristics of the wireless channel to make dynamic and flexible frequency resource allocation for different user equipment (UE), allowing for more efficient use of bandwidth and improved overall system performance.

While FSS offers many advantages, it also presents challenges. In an ideal case, all UEs can be assigned with their respective optimal bands, as shown in FIG. 1. For the same band a UE with a higher priority will be assigned with it. However, since legacy FSS always selects best band for a particular UE, this leads to frequency band fragments that results in insufficient use of resource blocks (RBs), an example of which is shown in FIG. 2. In other words, different UEs chooses their respective RBs based on their own advantages, leaving the band fragmented with many unused RBs. In LTE systems, the RB is the smallest unit of resource allocation, which is of about 0.5 ms duration and composed of 12 subcarriers in 1 OFDM (Orthogonal frequency-division multiplexing) symbol.

In addition, in legacy FSS methods, there is a heavy reliance of sounding reference signals (SRS) which are transmitted on the uplink (as shown in FIG. 3) and allow the network to estimate the quality of the channel at different frequencies, in order to assist frequency resource allocation. However, SRS is an dedicated reference signal, so the use of SRS occupies time-frequency resources and increase power consumption. In particular, for SRS sent by cell edge UE, the signal strength of the received SRS at a base transceiver station (BTS) is low, resulting in inaccurate channel quality measurement.

### SUMMARY OF INVENTION

Therefore, one of the aims of the invention is to develop improved uplink resource allocation methods in wireless communications networks.

Accordingly, the present invention, in one aspect, is a method of allocating uplink resources in wireless communications network. The wireless communication network includes a plurality of UEs and a base station (BS). The method includes the steps of: for each of the UEs, setting up a signal quality record for RBs; estimating a requirement of RBs for each of the UEs, based on a measured signal quality at the UE; selecting an optimal sub-band in a spectrum for each of the UEs based on their respective requirements of RBs; and updating the signal quality record for each of the UEs based on an updated signal quality at the UE in the optimal sub-band.

In some embodiments, for each UE the signal quality record is a table storing a Signal to Interference plus Noise Ratio (SINR) value for each of the RBs required by the UE.

In some embodiments, the SINR values in the table are initially set to a theoretical maximum value.

In some embodiments, when one RB contained in the table has been used by the corresponding UE, its SINR value in the table are further updated in the step of setting up the signal quality record for RBs.

In some embodiments, the measured signal quality is obtained based on a demodulation reference signal (DMRS) transmitted along with a scheduled uplink data.

In some embodiments, the step of estimating a requirement of RBs further includes, for each UE, steps of calculating a first signal quality threshold based on the measured signal quality, and calculating a required number of RBs based on the signal quality record and a data requirement of the UE.

In some embodiments, the first signal quality threshold is calculated using exponential effective SINR mapping.

In some embodiments, the required number of RBs is calculated on the basis of a data rate factor mapped from the first signal quality threshold.

In some embodiments, the data rate factor is determined at least based on modulation type, coding rate, spectral efficiency, and multi-input multi-output (MIMO) layers.

In some embodiments, the data requirement is a data throughput. The required number of RBs is calculated by dividing the data throughput using the data rate factor.

In some embodiments, the step of selecting an optimal sub-band in a spectrum for each of the UEs further includes, for each UE, the steps of comparing its required number of RBs with a RB number threshold; and allocating a sub-band with a highest possible data rate as the optimal sub-band to the UE, if its required number of RBs is larger than the RB number threshold, or if a sum of the required numbers of RBs of all the UEs is larger than a number of available RBs that is provided in the spectrum.

In some embodiments, the step of selecting an optimal sub-band in a spectrum for each of the UEs further includes, for each of the UEs, the step of allocating a sub-band which is as close as possible to a boundary of the spectrum as the optimal sub-band to the UE, if the sum of the required numbers of RBs of all the UEs is smaller than a number of available RBs that is provided in the spectrum.

In some embodiments, the RB number threshold is the same for all the UEs.

In some embodiments, the sub-band with a highest possible data rate is chosen based on one or more of the following criteria: a priority of the UE, and a priority of the sub-band.

In some embodiments, the priority of the sub-band is determined according to a distance between the sub-band and a boundary of the spectrum.

In some embodiments, the method further includes, after the step of selecting an optimal sub-band in a spectrum for each of the UEs, the step of adjusting a width of the optimal sub-band for each of the UEs, based on a comparison between a required data rate of the UE and a data rate that can be provided by the optimal sub-band of the UE.

In some embodiments, the step of adjusting the width of the optimal sub-band for each of the UEs further includes the steps of: comparing the required data rate of the UE to the data rate that can be provided by the optimal sub-band of the UE; calculating a second signal quality threshold based on the updated signal quality; increasing a bandwidth of the optimal sub-band to increase an allocated number of RBs of which signal qualities are above the second signal quality threshold, if the required data rate of the UE is larger than the data rate that can be provided by the optimal sub-band of the UE; and decreasing a bandwidth of the optimal sub-band to reduce an allocated number of RBs of which signal qualities are below the second signal quality threshold, if the required data rate of the UE is smaller than the data rate that can be provided by the optimal sub-band of the UE.

In some embodiments, the increasing and decreasing of the bandwidth include respectively increasing and decreasing a number of contiguous RBs for the optimal sub-band.

According to another aspect of the invention, there is provided a non-transitory computer-readable medium having computer instructions recorded thereon, the computer instructions, when executed on one or more processors, causing the one or more processors to perform operations according to the methods mentioned above.

According to a further aspect of the invention, there is provided a wireless communication system including a base station. The base station contains one or more processors; and memory containing instructions that, when executed by the one or more processors, cause the base station to perform operations according to the methods as mentioned above.

According to a further aspect of the invention, there is provided an improved uplink resource allocation method in a wireless communications network. The method includes: a) for each connected UE, creating a table to store the channel quality metric value for each RB and updating the channel quality metric value across the frequency band iteratively; b) for each UE to be scheduled, estimating the number of RBs sufficient to transmit the buffered data; c) for each UE to be scheduled, dividing the full frequency band into candidate sub-bands, prioritizing the candidate sub-bands; and d) according to the UE priority, for each UE to be scheduled, selecting a sub-band from the prioritized sub-bands and adjusting the number of contiguous RBs for scheduling.

In some embodiments, creating a table to store the measured channel quality metric value for each RB contains initializing the value of the channel quality metric (e.g., SINR) with the maximum value.

In some embodiments, updating the channel quality metric value across the frequency band iteratively includes updating channel quality metric value by the measurement natively performed during channel decoding.

In some embodiments, the channel quality measurement comprises measuring channel quality metric value based on the DMRS transmitted along with the scheduled uplink data.

In some embodiments, the method further includes determining the channel quality level for the selected RBs of a UE to be scheduled based on the table that stores the channel quality metric value for each RB, wherein the channel quality level contains average SINR or effective SINR for the selected RBs or any other metrics.

In some embodiments, the step of estimating the number of RBs sufficient to transmit the buffered data for each UE to be scheduled contains: determining a data rate factor as the average rate of data transmission per RB by channel quality level of the full band, modulation, coding rate, MIMO layers and any other related parameters; and calculating the estimated number of RBs as a function of the data rate factor and the size of the buffered data.

In some embodiments, the method further incudes estimating the data rate for a sub-band; determining a data rate factor as the average rate of data transmission per RB by channel quality level of the sub-band, modulation, coding rate, MIMO layers and any other related parameters; and estimating the data rate as a function of the data rate factor and number of RBs in the sub-band.

In some embodiments, each candidate sub-band is composed of contiguous RBs having channel quality metric value superior to the channel quality level of the full band.

In some embodiments, prioritizing the candidate sub-bands for each UE to be scheduled includes: if the estimated number of RBs of the selected UE is smaller than a predetermined threshold and the total estimated number of RBs of all the UEs to be scheduled is smaller than the number of RBs in the full band, prioritizing the candidate sub-bands according to the distance between the sub-band and the boundary frequencies; otherwise, prioritizing the candidate sub-bands based on the estimated data rate of the candidate sub-bands.

In some embodiments, the method further contains generating a sub-band sequence, wherein the sub-bands in the sequence is determined in turn according to the UE priority and candidate sub-bands prioritization of the corresponding UE.

In some embodiments, adjusting the number of contiguous RBs for scheduling contains: i) if the estimated data rate of the selected sub-band is sufficient to transmit the buffered data, determining the channel quality level of the sub-band; shrinking the sub-band to exclude RBs having channel quality metric value below channel quality level of the sub-band; among the two sub-bands with and without shrinkage, selecting the one that is sufficient to transmit the buffered data with fewer RBs for scheduling; and ii) if the estimated throughput of the selected sub-band is insufficient to transmit the buffered data: determining a channel quality level by all the RBs below the channel quality level of the full band; expanding the sub-band to include contiguous RBs having channel quality metric value superior to the determined channel quality level; among the two sub-bands with and without expansion, selecting the one that can support higher data rate for scheduling.

In some embodiments, adjusting the candidate sub-bands for each UE to be scheduled contains: if the sub-band is to be shrunk, calculate the effective SINR over the sub-band, selecting the RBs with SINR above the second effective SINR; if the sub-band is to be expanded, calculate the second effective SINR of the RBs with SINR below the first effective SINR, selecting the RBs with SINR above the second effective SINR.

One can see that various embodiments of the invention therefore provide improved uplink resource allocation methods with feedback closed-loops, which enhance the overall throughput performance. Some key features of the method according to an exemplary embodiment include that the method adopts a SRS-free channel quality measurement, thus releasing more available resource. In addition, there is achieved sub-band prioritization to reduce RB fragment, and also, the assigned sub-bands can be further adjusted based on the data throughput need of one or more UE.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 shows a conventional FSS method, and from left to right the figure shows identification of candidate bands for each one of UE1-UE3, priorities in selecting optimal bands from UE1 to UE3, and the resulted frequency allocations for UE1-UE3.

FIG. 2 shows a possible waste of RBs (unused) in the spectrum for UE1-UE3 of FIG. 1.

FIG. 3 shows the transmission of SRS signals from three UEs in to a BTS.

FIG. 4 shows the main steps in a flow chart of a method of allocating uplink resources in wireless communications network, according to a first embodiment of the invention.

FIG. 5 shows graphically the SINR tables, frequency bands, and SINR thresholds associated with the steps of the method in FIG. 4.

FIG. 6 is an illustration of the process of estimating a requirement of RBs for UEs.

FIG. 7 shows a graph of the relationship between the SINR_{eff}, the data rate factor, the data rate, and the number of RBs.

FIG. 8 is an illustration of the process of prioritizing/allocating optimal sub-hands for multiple UEs.

FIG. 9 is an illustration of the process of further adjusting the optimal sub-hand of a UE based on its required data rate and the data rate the sub-hand can provide before adjustment.

### DETAILED DESCRIPTION OF PREFERRED EMBODIMENTS

Exemplary embodiments of the invention provides methods of an improved uplink resource allocation method in wireless communications network. Such methods are able to achieve higher overall throughput than conventional methods. A highlight of the methods is that instead of using the SRS which is an additional payload occupying the time-frequency resources, the methods leverage the inherent characteristics of the wireless channel (such as the SINR as a metric), allowing for more efficient use of radio resources and width and improved overall system performance.

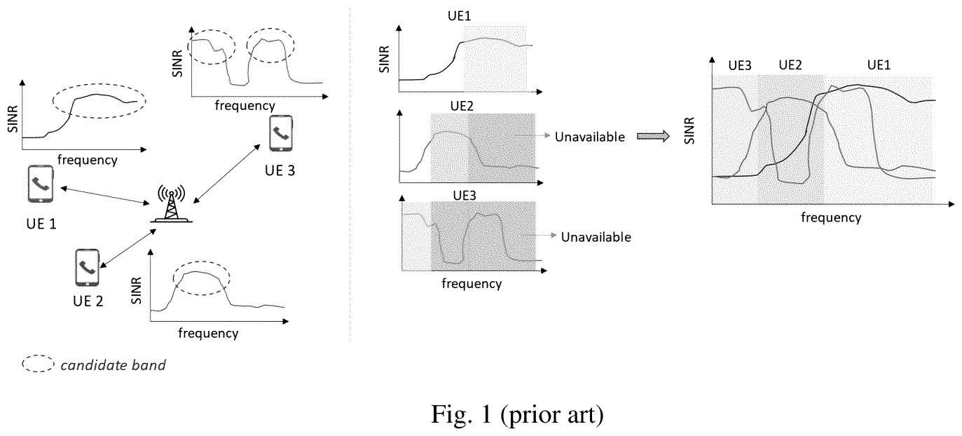

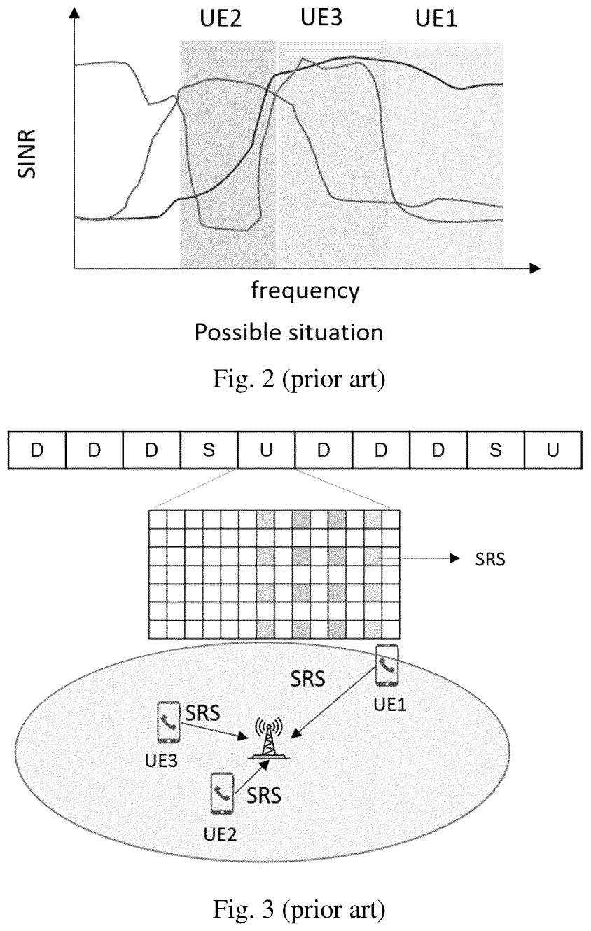

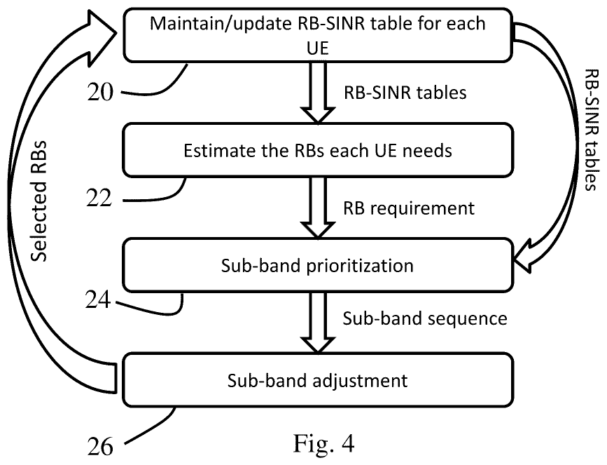

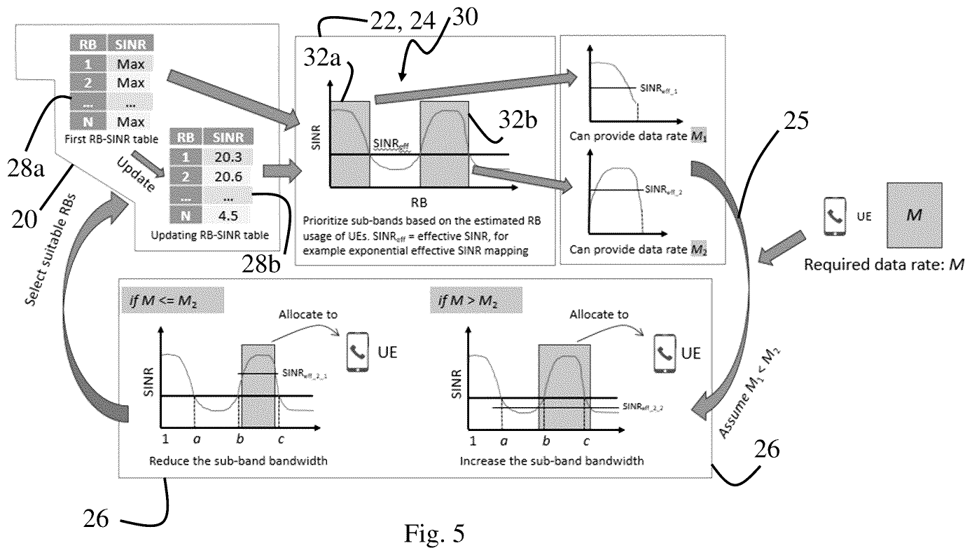

Referring to FIGS. 4-5, the first embodiment is a method of allocating uplink resources in a wireless communications network. The wireless communication network contains a plurality of UE and a BS (see FIG. 1 for example). The method contains four main steps, which are Step 20 in which a RB-SINR table is set up, maintained and updated for each of the UEs, Step 22 in which the required number of RBs for transmitting buffered data (uplink data) is estimated for each UE, Step 24 in which sub-bands are prioritized and allocated to different UEs, and Step 26 the optimal sub-bands for the UEs are further adjusted to offer optimization of the usage of the radio resources for the UEs. Each of the Steps 20, 22, 24 and 26 may be implemented as a separate hardware or software module, or a combined hardware and software module, as skilled persons will understand. Alternatively, one or more of the Steps 20, 22, 24 and 26 may be implemented by different computer instructions or software codes that are executed by the same processor(s). The invention is not limited by how the modules mentioned herein are implemented in the wireless communication network.

In the next section each of the Steps 20, 22, 24 and 26 will be described in detail. It should be noted that Step 26 is only optional, that for the method to be carried out it is not necessary to perform Step 26. Nonetheless, the further adjustment in Step 26 to the optimal sub-bands allocated in Step 24, could provide more preferable results by maximizing the data rates that can be provided for the UEs.

Next, Step 20 will be described in more detail with reference to FIG. 5. Assume that there are K UEs (not shown) in the wireless communication network which are associated with a BS (not shown), then in Step 20 the BS will set up, for each of the UEs, an RB-SINR table which is used as a signal quality record. FIG. 5 shows two such tables 28a, 28b for one UE, which are different in that table 28a represents an initial table, with all the values of SINR contained in the table as “Max”, whereas table 28b is updated from table 28a. The value “Max” in table 28a refers to a largest possible value that the wireless communication system allows for the SINR, for example 30 dB. Table 28a is set up with the maximum SINR values because initially there is no measured values for the SINR, so a default value of “Max” needs to be filled in table 28a. However, when the actual, measured SINR value for one or more RBs become available after the one or more RBs has been used by the UE, then table 28a can be updated with one or more of its SINR entries replaced with the actual SINR values. Table 28b is an example of the updated table from table 28a, and one can see that each RB has a different SINR value in table 28b, but all these SINR values are lower than the exemplary value of 30 dB as mentioned above. This is because the actual SINR values in a wireless communication network are always smaller than ideal values, and for different RBs (as they are at different frequencies) their signal qualities will also be different.

As one can see, in both tables 28a, 28b, there are many rows each corresponding to an RB, and for the sake of easy illustration the number of rows/RBs in each of the tables 28a, 28b is indicated by N. In each row, there is contained an RB-SINR value for a particular RB. The number N represents the total number of RBs in the full band that are available for us in the wireless communication system, but the number of RBs that a particular UE can use is only part of the total number N.

The SINR values as mentioned above can be measured, for example the SINR value as a channel quality metric value may be measured natively during the channel decoding process. In one example, the SINR value may be measured based on DMRS transmitted along with the scheduled uplink data. As skilled persons would understand, the DMRS is used for estimating a channel for demodulating the data carried by a certain physical channel.

Turn to FIGS. 5-7. In Step 22, for the K UEs, their respect requirements of RBs are estimated. The requirement of RBs for each UE is represented by the number of RBs it requires. To estimate the RB requirement of each UE, firstly an effective SINR is calculated based on measured signal quality. The effective SINR is used as a first signal quality threshold, and can be obtained for example by using exponential effective SINR mapping (EESM). Details of the EESM may be found in Lagen, Sandra, et al. “New radio physical layer abstraction for system-level simulations of 5G networks.” ICC 2020-2020 IEEE International Conference on Communications (ICC). IEEE, 2020, which is incorporated by reference in its entirety herein. The effective SINR is a metric which indicate the average performance of the band according to the different SINR over the band. It should be noted that for each UE, the effective SINR, denoted as SINR_{eff}, may be different due to the fact that signal quality received at each UE might be different due to distance with the BS, obstacles on the transmission path, etc. It can be seen from FIG. 5 that the SINR_{eff} is a single value for the UE across the entire spectrum.

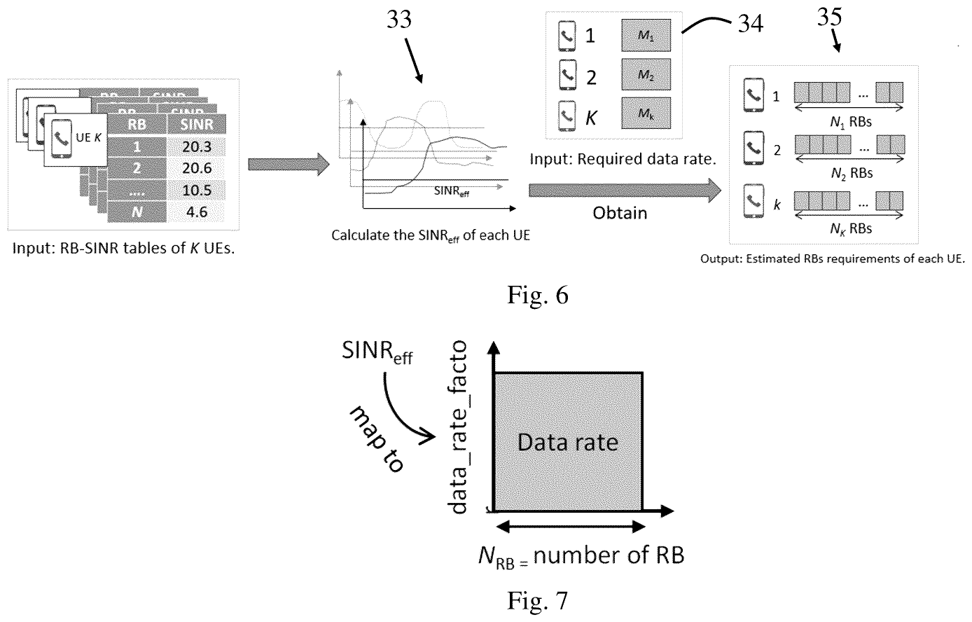

FIG. 6 shows another example of how to estimate the RB requirement of several UEs. Assume that there are three UEs, which are UE 1, UE 2 and UE K, then an RB-SINR table for each of UE 1, UE 2 and UE K is used as an input to calculate the SINR_{eff} of the respective UE in Step 33, thus obtaining three SINR_{eff} for UE 1, UE 2 and UE K respectively. Next, after the SINR_{eff} is determined for a UE, a required number of RBs for the UE is calculated. The required number of RBs is calculated based on the RB-SINR table and a data requirement of the UE. The data requirements of UE 1, UE 2 and UE K are respectively M₁, M₂ and M_{K}, as shown in box 34 in FIG. 6. With the knowledge of the data requirement of a UE, and its SINR_{eff}, the required number of RBs can be calculated in Step 35.

More specifically, FIG. 7 shows how the SINR_{eff} may be mapped to a data rate factor, which in turn is used to calculate the required number of RBs of the UE. The data rate factor is the average rate of data transmission per RB for a particular UE and is mapped from the SINR_{eff}. This can be understood by the requirement that for any UE, only those RBs that have the SINR values above the SINR_{eff} can be considered for using by the UE. However, the available number of RBs fulfilling the above criteria is different from UE to UE, since the channel quality level (which is represented by the SINR_{eff}) of the full band of each UE is almost always different. As such, the average rate of data transmission per RB is dependent on SINR_{eff}, as well as on a number of other factors including the modulation type, the coding rate, the spectral efficiency, and the MIMO layers. Once the data rate factor is determined for a UE, then the required number of RBs, represented by N_{RB}, can be calculated by dividing the required data rate (that is, a required data throughput, which for example is dependent on the size of the buffered data at the UE) of the UE using the data rate factor. In other words, the data rate of the UE is the product of the data rate factor and N_{RB}, as shown in FIG. 7. Referring back to FIG. 4, the output of Step 22 in the example is then the required numbers of RBs for UE 1, UE 2 and UE K respectively, which are denoted by N₁, N₂ and N_{K}.

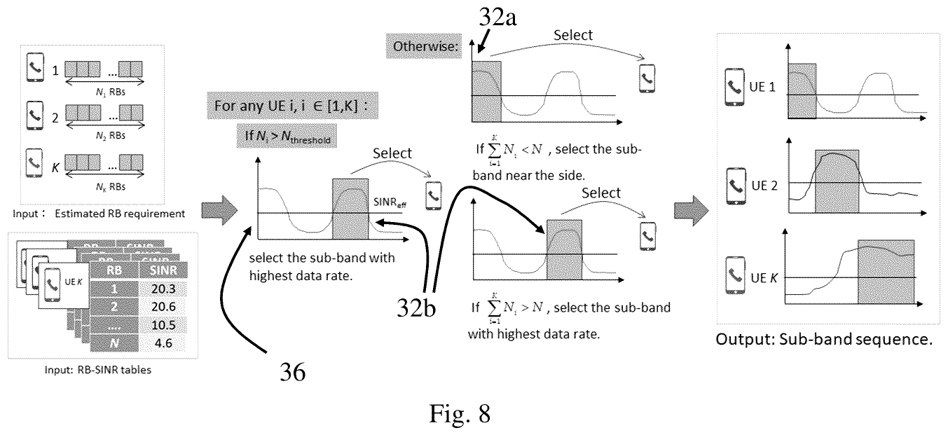

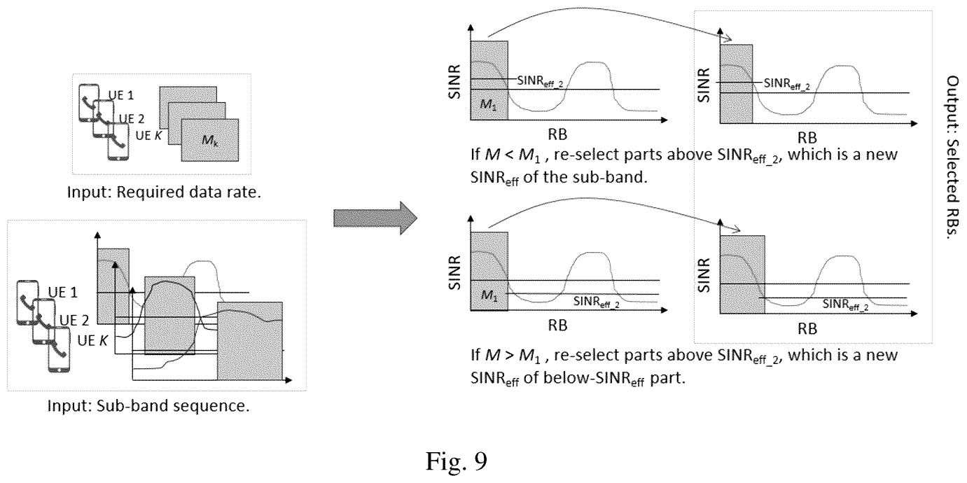

Next, in Step 24 an optimal sub-band in a spectrum (i.e., the full band available for the UEs in the network) for each of the UEs is selected based on their respective requirements of RBs that were obtained in Step 22. The detail of Step 24 is shown in FIG. 8. In this example, the inputs that are required to perform Step 24 include the required numbers of RBs for the UEs (FIG. 8 shows UE 1, UE 2 and UE K, and their required numbers of RBs are denoted by N₁, N₂ and N_{K} respectively), as well as the RB-SINR tables for the UEs. Then, in Step 36, for any UE i (i∈[1, K]) a comparison of its required number of RB Nᵢ is compared with a threshold N_{threshold}. The RB number threshold N_{threshold} is a predetermined threshold that is the same for all the UEs, for example the value of N_{threshold} could be half of the total number of RBs in the spectrum. It should be noted that the specific steps as illustrated in FIG. 8 for Step 24 are just one of many possible ways of prioritizing the sub-bands, which should not be taken as limiting the invention by any means.

Based on the comparison result of Nᵢ and N_{threshold}, if Nᵢ>N_{threshold}, then for UE i a candidate sub-band with the highest possible data rate is chosen as the optimal sub-band. Note that for each UE there may be one or more candidate sub-bands, which is determined for a UE based on its SINR_{eff}. For example, see a chart in FIG. 5 indicated by arrow 30, which shows the exemplary SINR variation along the RB axis (which is in fact along a frequency axis) for a UE, and the calculated SINR_{eff} which is a horizontal line that is like a threshold. In this exemplary chart, one can see that near two ends of the spectrum the SINR is above the threshold of SINR_{eff}, which is represented by two discrete grey regions. However, near the middle point of the spectrum the SINR is below the threshold. Therefore, for this UE there are two sub-bands 32a, 32b that may be considered as candidate sub-bands, each of which is presented by one of the two grey regions. In Step 36, if Nᵢ>N_{threshold}, then in the case of chart 30 of FIG. 5, the sub-band 32b will be chosen as the optimal sub-hand because it offers a higher data rate, as indicated by the arrow 25 in FIG. 5. The sub-band 32b is also shown as the optimal sub-band in FIG. 8 in the case of Nᵢ>N_{threshold}.

On the other hand, if in Step 36 it is determined that Nᵢ≤N_{threshold}, then further comparisons need to be made, which is to compare a sum of the required numbers of RBs of all the UEs (denoted by

$${\sum }_{i = 1}^{K} {N}_{i} )$$

with a number of available RBs that is provided in the spectrum (denoted by N). If

$${\sum }_{i = 1}^{K} {N}_{i} < N ,$$

this means that there are sufficient RBs for use by all UEs, and for UE i, a sub-band as “remote” as possible is chosen as the optimal sub-band. In other words, a sub-band that is away from the mid-frequency of the spectrum, and is as close as possible to a boundary of the spectrum, is chosen. Since there are enough number of RBs for use in the spectrum, choosing a side sub-band still means that contiguous RBs can be allocated for the use of the UE so the requested data rate of the UE can be met. In the case of chart 30 of FIG. 5, the sub-band 32a will be chosen as the optimal sub-hand here because it is closest to a boundary of the spectrum. The sub-band 32a is also shown as the optimal sub-band in FIG. 8 in the case of Nᵢ≤N_{threshold} AND

$${\sum }_{i = 1}^{K} {N}_{i} < N .$$

On the other hand, if in Step 36 it is determined that Nᵢ≤N_{threshold}, but

$${\sum }_{i = 1}^{K} {N}_{i} > N ,$$

then this means that there are insufficient RBs for use by all UEs, and for UE i, a sub-band offering a highest possible data rate will be chosen as the optimal sub-hand, similar to the case when Nᵢ>N_{threshold}. This is because if the total number of RBs in the spectrum is insufficient for all the UEs, then for the current UE i, a sub-band offering the contiguous RBs should be provided to UE i while such sub-band is available. In this way, it can be ensured as much as possible UEs can be allocated with their optimal sub-bands that offer the highest possible data rates. In the case of chart 30 of FIG. 5, the sub-band 32b will be chosen as the optimal sub-hand here and the sub-band 32b is also shown as the optimal sub-band in FIG. 8 in the case of Nᵢ≤N_{threshold} AND

$${\sum }_{i = 1}^{K} {N}_{i} > N .$$

The last part of FIG. 8 shows the output of Step 24, where different UEs including UE 1, UE 2 and UE K are each assigned with an optimal sub-band. One can see that these three optimal sub-bands are offset from each other on the spectrum with no overlapping. In other words, the optimal sub-bands are resulted from a division of the spectrum. In addition, there is a sequence for the sub-bands, as the three sub-bands are allocated to UE 1, UE 2 and UE K in order as frequency increases. In one example, the sub-band sequence is determined in turn according to the UE priority and candidate sub-bands prioritization of the corresponding UE. The UE priority refers to priorities given to different UEs in choosing their optimal sub-bands, and is set for example by the cellular network operator. On the other hand, the candidate sub-bands prioritization is just how one candidate sub-band is chosen over another one, as mentioned above about Step 36.

Turning to Step 26 in FIG. 5, as mentioned above in the example of FIG. 5, the chart 30 shows that there are two candidate sub-bands 32a, 32b identified for a UE after Step 22 is conducted. It can be seen from the chart 30 that the two sub-bands 32a, 32b have different bandwidths, with the sub-band 32a narrower than the sub-band 32b. Since each of the sub-bands 32a, 32b could provide a data rate, it is apparent that the wider sub-band 32b could provide a data rate (denoted by M₂) which is larger than that provided by the narrower sub-band 32a (denoted by M₁). Before Step 26 is conducted, in Step 24 an optimal sub-band has already been allocated to a UE, and for the sake of illustration, the sub-band 32b that provides the data rate of M₂ is chosen as the optimal sub-band for the UE. However, Step 26 is conducted to further optimize the allocated sub-band to the UE so that an appropriate width of the sub-band will be provided to the UE, with an attempt to avoid waste of the radio resource or providing insufficient radio resource to the UE.

In Step 26, the required data rate of the UE (denoted by Mₖ for UE k) and the sub-band sequence are provided as inputs, as shown in FIG. 9. The sub-band sequence as mentioned above contains information of respective sub-bands allocated to all the UEs. Then, for UE k, by comparing Mₖ with the data rate that can be provided by the optimal sub-band of the UE k, further adjustments (e.g., fine-tuning) of the bandwidth of the optimal sub-band become possible.

In particular, in Step 26, firstly a second signal quality threshold is calculated based on updated signal quality of the UE. The updated sign quality is provided by the signal quality record as mentioned above, for example the RB-SINR table in which measured SINR values for one or more RBs are kept. The second signal quality threshold is again an effective SINR, denoted by SINR_{eff_2}, but this time the SINR_{eff_2} is computed according to the optimal sub-band for the UE, whereas the previously mentioned SINR_{eff} in Step 22 is calculated for the full band. For example, if the sub-band is to be shrunk (as will be described in more detail below), SINR_{eff_2} is computed within the sub-band. However, if the sub-band is to be expanded, then SINR_{eff_2} is computed using the unselected areas (areas outside all the sub-bands of the UE). As such, the SINR_{eff_2} is a more reliable indication of the channel quality level as compared to SINR_{eff}.

With SINR_{eff_2} becoming available, the required data rate of the UE is then compared to the data rate that can be provided by the optimal sub-band of the UE. In the example of FIG. 5, M denotes the required data rate of the UE and M₂ denotes the data rate that can be provided by the optimal sub-band 32b of the UE. If M>M₂, then it means that the allocated optimal sub-band to the UE in Step 24 is not enough, then the bandwidth of the optimal sub-band is increased, and the sub-band is expanded. The expanding of the sub-band leads to inclusion of contiguous RBs having channel quality metric value superior to the determined channel quality level (which is SINR_{eff_2}) but at the same time inferior to the SINR_{eff}. Then, between the sub-band 32b before the expansion, and the expanded sub-band, the one that could support higher data rate will be chosen as the new sub-band for the UE.

On the other hand, If M<M₂, then it means that the allocated optimal sub-band to the UE in Step 24 is more than enough, so the bandwidth of the optimal sub-band is decreased, and the sub-band is shrunk. The shrinking of the sub-band leads to exclusion of contiguous RBs having channel quality metric value below the determined channel quality level (which is SINR_{eff_2}). In other words, only the RBs having channel quality metric value superior to both SINR_{eff_2} and SINR_{eff} will remain. The shrunk sub-band is then chosen as the new sub-band for the UE. In the example of FIG. 9, the adjustment of the optimal sub-band is similar, with the only difference is that in FIG. 9 the data rate that can be provided by the optimal sub-band of the UE as determined in Step 24 is denoted as M₁. One can see that by adopting more than one thresholds, the number of RBs can be more flexibly expanded or shrunk for a particular UE.

After the Step 26, the method of allocating uplink resources in a wireless communications network as shown in FIG. 4 is then completed. Nonetheless, it should be noted that in real applications the method can be iterated many times or on a continuous basis, since the optimal sub-band allocated to each UE is not fixed but should be flexible and updated as necessary if for example the UE is moving, leading to a change in its determined channel quality level.

The outcome of Step 26, which is the adjusted optimal sub-band for the UE, can be converted to selected RBs (over the sub-band), and the selected RBs can be fed to the RB-SINR table to update the SINR values of RBs. In other words, the method as mentioned above forms a feedback loop where the resource allocation result is used to improve the signal quality record to help with more accurate and targeted source allocation for the UEs in the future.

It should be note that as mentioned above, Step 26 is not a must in performing in method according to embodiments of the invention. In some embodiments of the invention, the method could end at Step 24, and in that case, the initial optimal sub-band after prioritization could also be converted to selected RBs which are used to update the RB-SINR table. As mentioned, Step 26 is fine-tuning of the optimal sub-band, but performing it or not, there is always feedback available to form a loop and to be used to update the table.

The method of FIG. 5 can achieve higher overall throughput while substantially maintaining the performance of UEs with low SINR (e.g., SINR<10 dB). The method improves the overall network throughput by reducing frequency band fragments to fulfil the high throughput needs. With the use of the method, sub-optimal bands may be allocated to UE, resulting in a slightly higher number of low-SINR UEs (e.g., SINR<10 dB).

The methods of allocating uplink resources in wireless communications networks according to embodiments of the invention may be used in many scenarios. For example, the method may be used for surveillance and sensor monitoring on construction sites. Typically, a construction company utilizes high uplink throughput for video streaming and lower rates for sensor data transmission to enable a secure and efficient work environment. Thus, for a UE that corresponds to a camera or CCTV, a wider sub-band be assigned, while for a UE that corresponds to a sensor, a narrower sub-band can be assigned. The width of the sub-band corresponds to the number of RBs usable for the sub-band. In another example, the method may be applied to live sports streaming. During a major sports event, a broadcasting company utilizes high uplink throughput to stream the game live to millions of viewers. In comparison, spectators at the venue use lower uplink throughput to share updates and photos on social media. Therefore, for a UE that corresponds to the game stream, a wider sub-band be assigned, while for a UE that corresponds to a spectator, a narrower sub-band can be assigned.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

For example, the effective SINR is used as the signal quality threshold in exemplary embodiments mentioned above. Those skilled in the art should understand that the effective SINR is not mandated—any other suitable threshold may be used to assess the channel quality level. For example, the threshold may be set as the average SINR.

The functional units and modules of the systems and methods in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

What is claimed is:

1. A method of allocating uplink resources in a wireless communications network; the wireless communication network comprising a plurality of user equipment (UE) and a base station (BS), the method comprising:
a) for each of the UEs, setting up a signal quality record for resource blocks (RBs);
b) estimating a requirement of RBs for each of the UEs, based on a measured signal quality at the UE; and
c) selecting an optimal sub-band in a spectrum for each of the UEs based on their respective requirements of RBs; and
d) updating the signal quality record for each of the UEs based on an updated signal quality at the UE in the optimal sub-band.

2. The method of claim 1, wherein for each said UE, the signal quality record is a table storing a Signal to Interference plus Noise Ratio (SINR) value for each of the RBs required by the UE.

3. The method of claim 2, wherein the SINR values in the table are initially set to a theoretical maximum value.

4. The method of claim 2, wherein when one said RB contained in the table has been used by the corresponding UE, its SINR value in the table are further updated in Step a).

5. The method of claim 1, wherein the measured signal quality is obtained based on a demodulation reference signal (DMRS) transmitted along with a scheduled uplink data.

6. The method of claim 1, wherein Step b) further comprises, for each said UE, the steps of:
e) calculating a first signal quality threshold based on the measured signal quality; and
f) calculating a required number of RBs based on the signal quality record and a data requirement of the UE.

7. The method of claim 6, wherein the first signal quality threshold is calculated using exponential effective SINR mapping.

8. The method of claim 6, wherein the required number of RBs is calculated on the basis of a data rate factor mapped from the first signal quality threshold.

9. The method of claim 8, wherein the data rate factor is determined at least based on modulation type, coding rate, spectral efficiency, and multi-input multi-output (MIMO) layers.

10. The method of claim 8, wherein the data requirement is a data throughput; the required number of RBs calculated by dividing the data throughput using the data rate factor.

11. The method of claim 1, wherein Step c) further comprises, for each of the UEs:
g) comparing its required number of RBs with a RB number threshold; and
h) allocating a sub-band with a highest possible data rate as the optimal sub-band to the UE, if its required number of RBs is larger than the RB number threshold, or if a sum of the required numbers of RBs of all the UEs is larger than a number of available RBs that is provided in the spectrum.

12. The method of claim 11, wherein Step c) further comprises, for each of the UEs:
i) allocating a sub-band which is as close as possible to a boundary of the spectrum as the optimal sub-band to the UE, if the sum of the required numbers of RBs of all the UEs is smaller than a number of available RBs that is provided in the spectrum.

13. The method of claim 11, wherein the RB number threshold is the same for all the UEs.

14. The method of claim 11, wherein the sub-band with a highest possible data rate is chosen based on one or more of the following criteria: a priority of the UE, and a priority of the sub-band.

15. The method of claim 14, wherein the priority of the sub-band is determined according to a distance between the sub-band and a boundary of the spectrum.

16. The method of claim 1, further comprises, after Step c), the following step:
j) adjusting a width of the optimal sub-band for each of the UEs, based on a comparison between a required data rate of the UE and a data rate that can be provided by the optimal sub-band of the UE.

17. The method of claim 16, wherein Step j) further comprises, for each of the UEs:
k) comparing the required data rate of the UE to the data rate that can be provided by the optimal sub-band of the UE;
l) calculating a second signal quality threshold based on the updated signal quality;
m) increasing a bandwidth of the optimal sub-band to increase an allocated number of RBs of which signal qualities are above the second signal quality threshold, if the required data rate of the UE is larger than the data rate that can be provided by the optimal sub-band of the UE; and
n) decreasing a bandwidth of the optimal sub-band to reduce an allocated number of RBs of which signal qualities are above the second signal quality threshold, if the required data rate of the UE is smaller than the data rate that can be provided by the optimal sub-band of the UE.

18. The method of claim 17, wherein the increasing and decreasing of the bandwidth comprise respectively increasing and decreasing a number of contiguous RBs for the optimal sub-band.

19. A non-transitory computer-readable medium having computer instructions recorded thereon, the computer instructions, when executed on one or more processors, causing the one or more processors to perform operations according to the method according to claim 1.

20. A wireless communication system comprising a base station, the base station comprising:
one or more processors; and
memory containing instructions that, when executed by the one or more processors, cause the base station to perform operations according to the method of claim 1.
